(19) United States
(12) Patent Application Publication
(10) Pub. No.: US 2013/0305172 A1
(43) Pub. Date: Nov. 14, 2013

(54) Pen Tool Editing Modes

(71) Applicants: Pushkar Prakash Joshi, Fremont, CA (US); Anthony C. Mowatt, Emeryville, CA (US); Eric J. Mueller, Los Gatos, CA (US); Jason Long, Sunnyvale, CA (US)

(72) Inventors: Pushkar Prakash Joshi, Fremont, CA (US); Anthony C. Mowatt, Emeryville, CA (US); Eric J. Mueller, Los Gatos, CA (US); Jason Long, Sunnyvale, CA (US)

(73) Assignee: Motorola Mobility, Inc., Libertyville, IL (US)

(21) Appl. No.: 13/468,208

(22) Filed: May 10, 2012

(51) Int. Cl. G06F 3/048

(52) U.S. Cl. 715/764

(57) ABSTRACT

In embodiments of pen tool editing modes, drawing regions of a drawing application can be configured for image creation and editing. A pen tool of the drawing application can be configured for selection to both create an image for display and edit an image in a drawing region. Editing modes of the pen tool can be initiated based on pen tool inputs and without selection of a selection tool. A first pen tool editing mode may be initiated based on a pen tool input to create an image in a new drawing region. Alternatively, a second pen tool editing mode may be initiated based on a pen tool input to create an image in an existing drawing region. Alternatively, a third pen tool editing mode may be initiated based on a pen tool input as a selection of an image to edit the image.

### BACKGROUND

Drawing applications enable users to create and edit images for display. Many of these drawing applications include a variety of drawing tools that enable a user to create different shapes, enter text, and so on, according to inputs received from the user. To edit an image, conventional drawing applications often require the user to select a portion of the image for editing. Typically, the user first initiates a selection tool to select the portion of the image for editing, and then changes to a drawing tool with a second selection to edit the image. However, many novice users may find using the drawing tools of conventional drawing applications difficult because of the repeated switching between the selection tool to select an image and the drawing tools to edit the image.

### BRIEF DESCRIPTION OF THE DRAWINGS

Embodiments of pen tool editing modes are described with reference to the following Figures. The same numbers may be used throughout to reference like features and components that are shown in the Figures:

FIG. 1 illustrates an example system in which embodiments of pen tool editing modes can be implemented.

FIG. 2 illustrates an example of pen tool editing modes in accordance with one or more embodiments.

FIG. 3 illustrates example method(s) of pen tool editing modes in accordance with one or more embodiments.

FIG. 4 illustrates example method(s) of pen tool editing modes in accordance with one or more embodiments.

FIG. 5 illustrates various components of an example electronic device that can implement embodiments of pen tool editing modes.

### DETAILED DESCRIPTION

A user-friendly drawing experience is provided in a drawing application by minimizing the number of times that a user switches between a selection tool and drawing tools to create and edit an image, and by invoking the selection tool only when it is intuitive to do so. In embodiments of pen tool editing modes, repeated selections of the selection tool are minimized by switching between multiple pen tool editing modes that enable a pen tool to both create and edit images in drawing regions of a drawing application without invoking the selection tool. Different pen tool editing modes can be initiated by the drawing application depending on whether a pen tool input corresponds to a new drawing region, an existing drawing region, or an image.

The multiple pen tool editing modes can be changed when selected by the pen tool or the selection tool according to whether a new drawing region, an existing drawing region, or an image is selected. For example, a user can select a new drawing region (e.g., using the pen tool or the selection tool), and a pen tool editing mode is initiated to create an image in the new drawing region. Alternatively, the user can select an existing drawing region and a pen tool editing mode is initiated to create an image (or add to an existing image) in the existing drawing region. Alternatively, the user can select an image and a pen tool editing mode is initiated that enables the user to edit the selected image. In embodiments, the various pen tool editing modes can be initiated according to the pen tool inputs and without invoking a selection tool of the drawing application.

While features and concepts of pen tool editing modes can be implemented in any number of different devices, systems, and/or configurations, embodiments of pen tool editing modes are described in the context of the following example devices, systems, and methods.

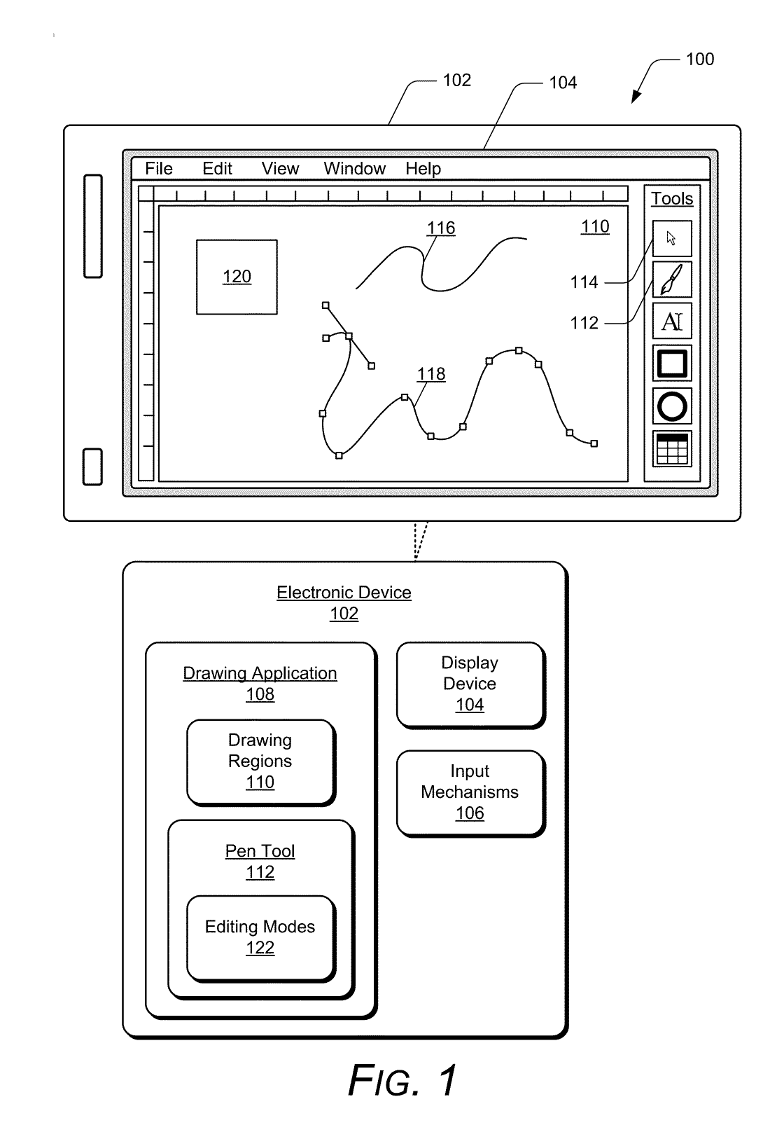

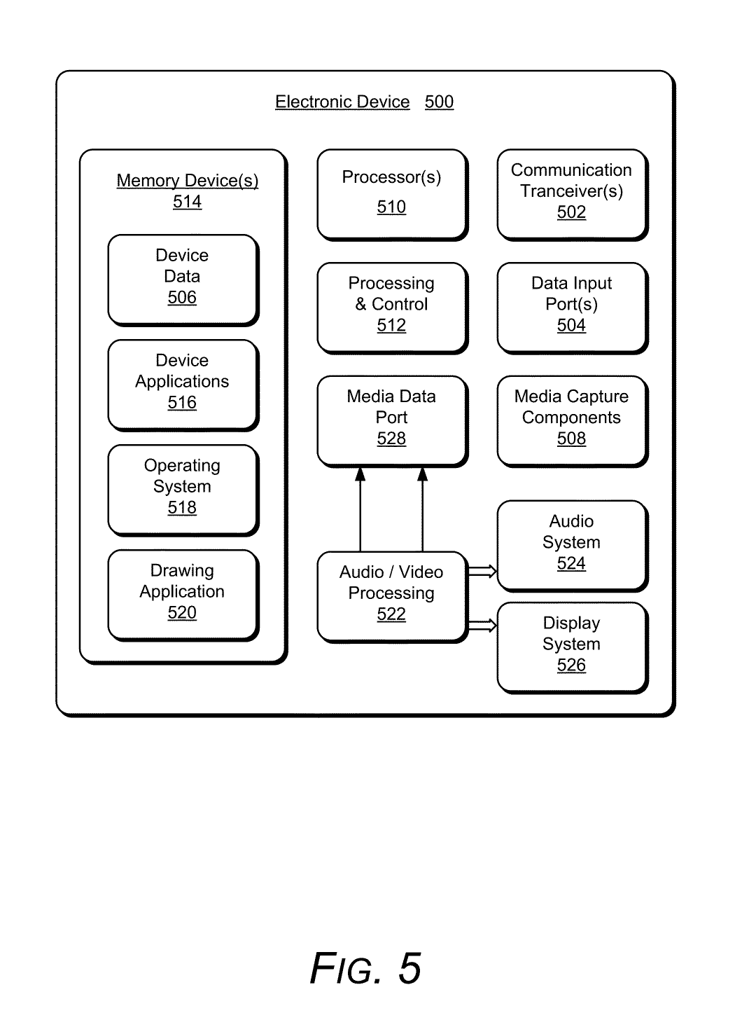

FIG. 1 illustrates an example system 100 in which embodiments of pen tool editing modes can be implemented. The example system 100 includes an electronic device 102, which is shown as a tablet or other portable device having an integrated touch screen display that is implemented as both an integrated display device 104 and an input mechanism. In implementations, various types of computer devices, display devices, and input mechanisms 106 may be used, such as a personal computer having a monitor, a keyboard, and a mouse; a laptop or tablet with an integrated display device and keyboard with a touchpad; or a smart phone or other mobile device with a small integrated display device, a telephone keypad, and navigation keys. The electronic device 102 can be implemented with various components, such as one or more processors and memory, as well as with any combination of differing components as further described with reference to the example electronic device shown in FIG. 5.

In embodiments, the electronic device 102 includes a drawing application 108 that can be implemented as computer-executable instructions, such as a software application, and executed by one or more processors to implement the various embodiments of pen tool editing modes described herein. The drawing application 108 includes drawing regions 110 and drawing tools, such as a pen tool 112 and a selection tool 114 that are displayed on the display device 104 of the electronic device. The drawing application 108 is implemented to receive inputs to select various items as well as to create and/or edit images. For example, inputs may be received via the input mechanisms 106 to select drawing tools, such as to select the pen tool 112 and the selection tool 114. Inputs may also be received to create and/or edit images in the drawing regions 110, such as to create and/or edit various types of images 116, 118, and 120. The input mechanisms 106 can include a variety of differing components, which may be any one or combination of a mouse, a keyboard, a stylus, a touch-sensitive interface configured to detect user-initiated touch contacts and/or touch gesture inputs, and any other type of input device. In general, the drawing application 108 receives inputs via the input mechanisms 106 and implements embodiments of pen tool editing modes.

In embodiments of pen tool editing modes, the drawing tools of the drawing application 108 can be selected based on input received via one or more of the input mechanisms 106 of the electronic device 102. For example, the pen tool 112 may be selected to create and/or edit the various images 116, 118, and 120 that are displayed in the drawing region 110 of the drawing application 108 on the display device 104. Alternatively, the selection tool 114 may be selected to select drawing regions, such as drawing region 110, or to select any of the various displayed images or sections of the displayed images. It should be noted that other drawing tools may also be selected based on input received via the one or more input mechanisms 106 to perform a variety of functions, such as to create and/or edit particular shapes, text, tables, add and/or change the color of images, display and/or change properties of images, and so on.

The drawing tools of the drawing application 108 can include a variety of editing modes. In embodiments, the pen tool 112 is implemented with editing modes 122 that can be initiated and used to create and/or edit images. The editing modes 122 of the pen tool 112 may be initiated based on inputs received while the pen tool is selected. When the pen tool 112 is the selected drawing tool, for instance, a pen tool input may be received that corresponds to the drawing region 110. Accordingly, an editing mode 122 of the pen tool 112 that is associated with inputs corresponding to drawing regions can be initiated. For example, an editing mode 122 of the pen tool 112 may be initiated based on an input of the pen tool to create an image in a new drawing region. Alternatively, an editing mode 122 of the pen tool 112 may be initiated based on an input of the pen tool within an existing drawing region to create an image in the existing drawing region.

Alternatively or in addition, when the pen tool 112 is the selected drawing tool, a pen tool input may be received that corresponds to an image, such as an input with the pen tool that is effective to select one of the various displayed images 116, 118, and 120 to edit the image. Accordingly, an editing mode 122 of the pen tool 112 that corresponds to image selection can be initiated based on selection of an image to edit the image. It should be noted that the editing mode 122 that corresponds to editing an image can be initiated based on an input with the pen tool (e.g., the input to select the image), but without invoking the selection tool 114.

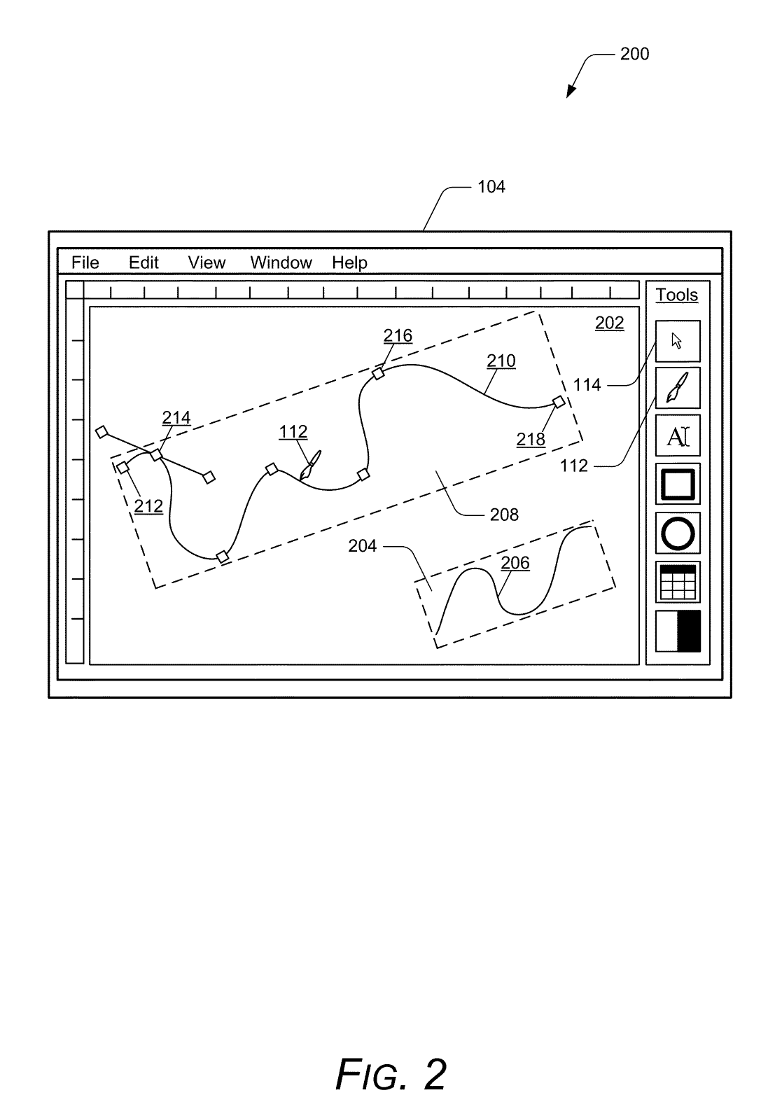

FIG. 2 illustrates an example 200 of the pen tool editing modes in accordance with the embodiments described herein. In this example, a drawing interface 202 of the drawing application 108 is displayed on the display device 104 of the electronic device 102, as described above with reference to FIG. 1. A first drawing region 204 is shown that bounds a displayed image 206, and a second drawing region 208 is shown that bounds a displayed image 210. The drawing regions 204 and 208 are indicated by the dashed lines but may be larger or smaller, shaped differently than those illustrated, and/or may overlap one another. A drawing region may be created in conjunction with the creation of an image, or may be created first and an image subsequently created within the existing drawing region. The illustrated drawing regions are examples and should not be seen to limit the drawing regions of the drawing application. In this example, the displayed image 210 is shown as segments between multiple anchor points, such as anchor points 212, 214, 216, and 218.

As discussed above, the pen tool 112 can be selected to both create and/or edit an image in a drawing region. For example, the pen tool 112 may be used to create and/or edit the images 206 and 210 in the respective drawing regions 204 and 208. The various pen tool editing modes 122 of the pen tool 112 for the drawing application 108 can be initiated based on pen tool inputs. In embodiments, the pen tool 112 includes a first pen tool editing mode, which may be initiated responsive to a pen tool input to create an image in a new drawing region. For example, the pen tool may be selected to create the image 210 in the drawing region 208, and based on the selection of the pen tool, the first pen tool editing mode is initiated. The first pen tool editing mode enables a user to set anchor points for segments of the image, such as a first anchor point 212, a second anchor point 214, and so on. In the first pen tool editing mode, a new drawing region may also be created when the first anchor point is set. For example, when the pen tool 112 is used to set the first anchor point 212, the drawing region 208 for the image 210 is also created.

Further, the first pen tool editing mode provides that segments of the image can be created in the drawing region between the anchor points, such as an image segment that is created between the first anchor point 212 and the second anchor point 214 when the second anchor point is set. In this way, the pen tool inputs to set a sequence of anchor points can be used to create the segments of the image 210 as each consecutive anchor point is set, such as the anchor points 212, 214, 216, and 218. Additionally, the first pen tool editing mode may enable a drawing region that corresponds to an image to expand around the image as the image is created. For example, when pen tool inputs set the sequence of anchor points to create the displayed image 210, the drawing region 208 can expand to bound the image as the segments of the image are created.

In embodiments, the pen tool 112 also includes a second pen tool editing mode, which may be initiated responsive to a pen tool input within an existing drawing region to create an image in the existing drawing region. For example, the drawing region 208 may be created prior to the displayed image 206 being created (i.e., the drawing region 204 exists before the image 206). The pen tool 112 can then be selected to create the image 206 in the drawing region 204 (i.e., an existing drawing region). The pen tool inputs can be received within the drawing region 204 and the image 206 is created responsive to the inputs.

The second pen tool editing mode may also be implemented to prevent an existing drawing region from expanding while an image is being created. As discussed above with reference to the first pen tool editing mode, a drawing region may expand as an image is created in the drawing region to bound the image. The second pen tool editing mode, however, prevents a drawing region from expanding as an image is created or added to the drawing region. For example, pen tool inputs may be received within the existing drawing region 204 to set anchor points for the image 206. However, the second pen tool editing mode prevents the drawing region 204 from expanding as the segments of the image 206 are created.

In embodiments, pen tool 112 includes a third pen tool editing mode, which may be initiated responsive to a pen tool input as a selection of an image to edit the image. For example, the pen tool 112 can be used to select an image, select a segment of an image, or initiate a selection near an image. Based on the selection of an image, a segment of the image, or near the image, the third pen tool editing mode is initiated to edit the image. Generally, the third pen tool editing mode may be used to perform editing functions on existing images.

For example, the third pen tool editing mode initiates the image 210 to be displayed with anchor points (e.g., the anchor points 212, 214, 216, 218, etc.) responsive to a pen tool input that selects the image, or a segment of the image, for editing. The third pen tool editing mode can also be used to adjust anchor points of an image. For example, the third pen tool editing mode enables multiple anchor points of an image to be selected concurrently, and then the segments of the image that correspond to the selected anchor points can be edited together based on the concurrent selection. The third pen tool editing mode can also enable anchor points to be added to a segment of an image when a pen tool input corresponds to a selection of the segment of the image.

The various pen tool editing modes can also enable a single anchor point of an image to be edited, and additional segments of the image to be adjusted based on editing the single anchor point. For example, pen tool inputs may be received as a selection to edit the anchor point 214 of the image 210. Based on the selection, the anchor point 214 is displayed with handles that can be selected to edit the position of the anchor point, such as by lengthening a previous or next handle, by rotating the handles clockwise or counterclockwise, and so on. This may then cause the other segments of the image 210 to be adjusted, such as the segments of the image that extend from the anchor point 214, based on the pen tool inputs to edit the anchor point.

In embodiments of the pen tool editing modes, a Bezier curve can be created based on a sequence of inputs to set anchor points for the Bezier curve. For example, the pen tool editing modes enable the image 210 to be created as a Bezier curve based on a sequence of pen tool inputs to set the anchor points that define the segments of the Bezier curve. Additionally, the pen tool editing modes enable additional anchor points to be added to segments of the Bezier curve when pen tool inputs are received to edit the Bezier curve.

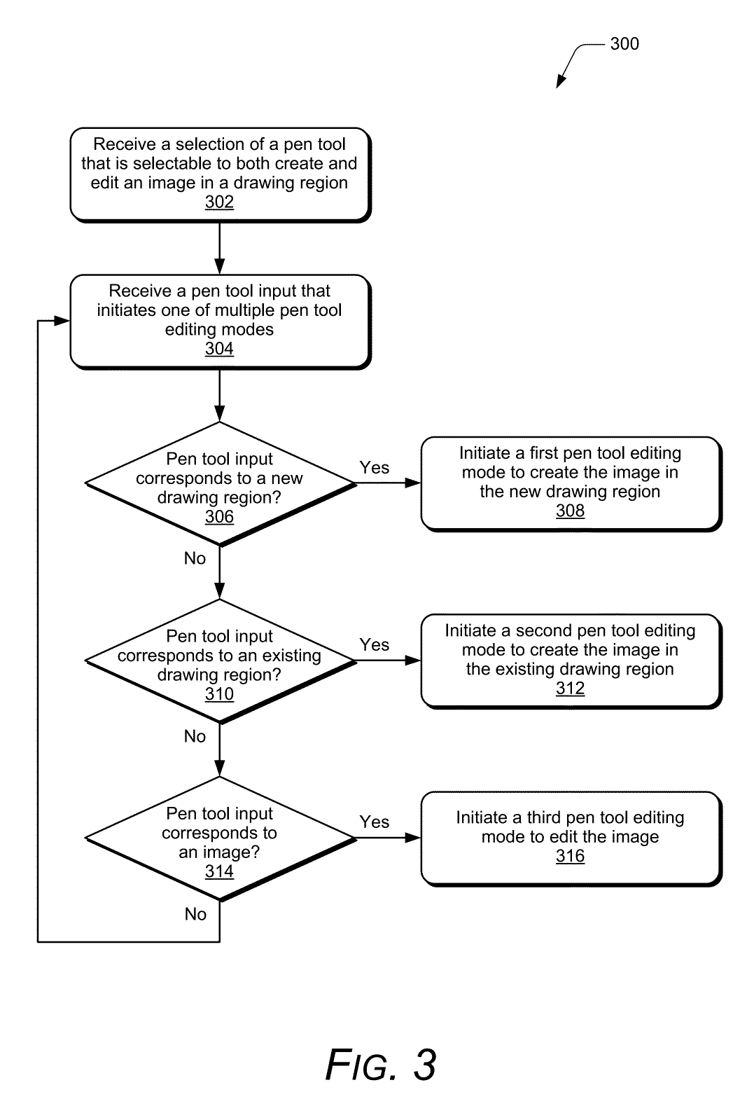

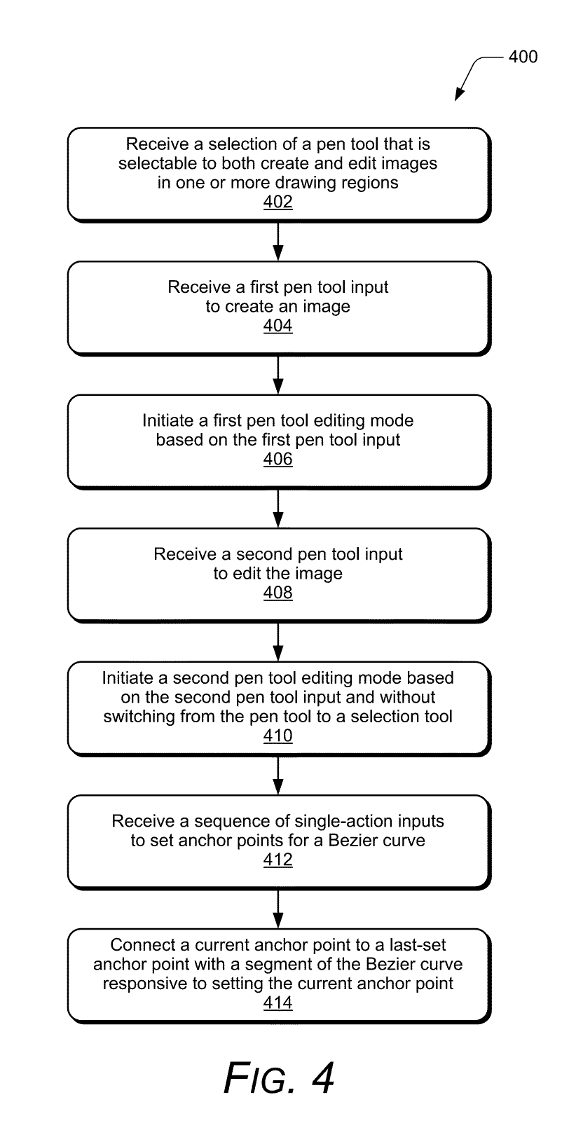

Example methods 300 and 400 are described with reference to respective FIGS. 3 and 4 in accordance with one or more embodiments of pen tool editing modes. Generally, any of the methods, components, and modules described herein can be implemented using software, firmware, hardware (e.g., fixed logic circuitry), manual processing, or any combination thereof. A software implementation represents program code that performs specified tasks when executed by a computer processor, and the program code can be stored in computer-readable storage media devices.

FIG. 3 illustrates example method(s) 300 of pen tool editing modes. The order in which the method blocks are described are not intended to be construed as a limitation, and any number or combination of the described method blocks can be combined in any order to implement a method, or an alternate method.

At block 302, a selection of a pen tool that is selectable to both create an image for display and edit the image in a drawing region of a drawing application is received. For example, a selection is received via an input mechanism 106 of the electronic device 102 (FIG. 1) to select the pen tool 112 of the drawing application 108. The pen tool 112 is selectable to create and/or edit images (e.g., images 116, 118, and 120) that are displayed in the drawing regions 110 on the display device 104 of the electronic device.

At block 304, a pen tool input that initiates one of multiple pen tool editing modes is received. For example, the pen tool 112 is the selected drawing tool of the drawing application 108, and an input is received via an input mechanism 106 relative to the drawing region 110 and/or the images 116, 118, or 120. As another example, a pen tool input is received relative to one of the drawing regions 204 or 208, or one of the displayed images 206 or 210. It should be noted that each of the multiple pen tool editing modes are initiated based on a pen tool input, and are initiated without switching from the pen tool 112 to a selection tool. For example, one of the multiple pen tool editing modes (i.e., a ‘current’ pen tool mode) may be initiated by switching from a previous pen tool editing mode without switching to a selection tool to initiate the current pen tool editing mode.

At block 306, a determination is made as to whether the pen tool input corresponds to a new drawing region. For example, the drawing application 108 at the electronic device 102 receives a pen tool input that does not correspond to an existing drawing region or to an existing image. The drawing application 108 then determines that the pen tool input corresponds to a new drawing region. If the pen tool input does correspond to a new drawing region (i.e., “yes” from block 306), then at block 308, a first pen tool editing mode is initiated to create an image in the new drawing region. For example, the first pen tool editing mode of the pen tool 112 is initiated to create the image 210 in a new drawing region, such as the drawing, region 208.

If the pen tool input does not correspond to a new drawing region (i.e., “no” from block 306), then at block 310, a determination is made as to whether the pen tool input corresponds to an existing drawing region (but not to an existing image within the drawing region). For example, the drawing application 108 at the electronic device 102 receives a pen tool input within an existing drawing region, such as within a previously created drawing region, and determines that the input corresponds to an existing drawing region. If the pen tool input does correspond to an existing drawing region, but not to an existing image within the drawing region (i.e., “yes” from block 310), then at block 312, a second pen tool editing mode is initiated to create an image in the existing drawing region. For example, the second pen tool editing mode of the pen tool 112 is initiated to create the image 210 in the existing drawing region 208, or to add to the image in the drawing region.

If the pen tool input does not correspond to an existing drawing region (i.e., “no” from block 310), then at block 314, a determination is made as to whether the pen tool input corresponds to a selection of an image. For example, the drawing application 108 at the electronic device 102 receives a pen tool input near an image, such as near one of the various images displayed in the drawing regions 110, and determines that the input near the image corresponds to a selection of the image to edit the image. If the pen tool input does correspond to a selection of an image (i.e., “yes” from block 314), then at block 316, a third pen tool editing mode is initiated to edit the image. For example, the third pen tool editing mode of the pen tool 112 is initiated to enable editing an existing image. If the pen tool input does not correspond to an image (i.e., “no” from block 314), then the method continues at block 304 to receive a subsequent pen tool input that initiates one of the multiple pen tool editing modes.

FIG. 4 illustrates example method(s) 400 of pen tool editing modes. The order in which the method blocks are described are not intended to be construed as a limitation, and any number or combination of the described method blocks can be combined in any order to implement a method, or an alternate method.

At block 402, a selection of a pen tool that is selectable to both create an image for display and edit the image in a drawing region of a drawing application is received. For example, a selection is received via an input mechanism 106 of the electronic device 102 (FIG. 1) to select the pen tool 112 of the drawing application 108. The pen tool 112 is selectable to create and/or edit images (e.g., images 116, 118, and 120) that are displayed in the drawing regions 110 on the display device 104 of the electronic device.

At block 404, a first pen tool input to create an image is received. For example, the pen tool 112 is the selected drawing tool of the drawing application 108 and a first pen tool input to create the image 210 is received, such as to set the anchor point 212. Alternatively, the first pen tool input is received to add a segment to the image 210 that is shown in the drawing region 208. At block 406, a first pen tool editing mode is initiated based on the first pen tool input. For example, the drawing application 108 at the electronic device 102 initiates the first pen tool editing mode of the pen tool 112 to create an image in a new or existing drawing region based on the first pen tool input.

At block 408, a second pen tool input to edit the image is received. For example, the drawing application 108 at the electronic device 102 receives a second pen tool input of one of the displayed images 206 or 210, or receives the second pen tool input near one of displayed images. The drawing application determines a pen tool input near an image as a selection of the image to edit the image. At block 410, a second pen tool editing mode is initiated based on the second pen tool input and without switching from the pen tool to a selection tool. For example, the drawing application 108 at the electronic device 102 initiates the second pen tool editing mode of the pen tool 112 to edit the selected image based on the second pen tool input near, or to select, the image.

At block 412, a sequence of single-action inputs to set anchor points for a Bezier curve are received. For example, the displayed image 210 is a Bezier curve and the drawing application 108 at the electronic device 102 receives a sequence of inputs to set the anchor points to create the segments of the Bezier curve, such as the anchor points 212, 214, 216, and 218. In implementations, each of the anchor points may be set responsive to a mouse click, a touch contact on a touch-sensitive interface, a touch contact of a stylus to a drawing pad, and the like.

At block 414, a current anchor point is connected to a last-set anchor point with a segment of the Bezier curve responsive to setting the current anchor point. For example, the anchor point 212 of the Bezier curve (i.e., the displayed image 210) may be a first anchor point that is set based on the sequence of inputs, anchor point 214 may be a second anchor point that is set based on the sequence, and so on. Thus, anchor point 216 may be a next-to-last anchor point that is set according to the sequence, and anchor point 218 may be a last anchor point that is set according to the sequence. When the anchor point 214 is set, it can be considered the ‘current’ anchor point and the anchor point 212 can be considered the ‘last-set’ anchor point. Responsive to setting the anchor point 214, the anchor point 214 is connected to the anchor point 212 with a segment of the Bezier curve.

FIG. 5 illustrates various components of an example electronic device 500 that can be implemented as any device described with reference to any of the previous FIGS. 1-4. The electronic device may be implemented as any one or combination of a fixed or mobile device, in any form of a consumer, computer, portable, user, communication, phone, navigation, gaming, media playback, and/or electronic device.

The electronic device 500 includes communication transceivers 502 that enable wired and/or wireless communication of device data 506, such as received data, data that is being received, data scheduled for broadcast, data packets of the data, etc. The device data 506 is an example of the drawing regions 110 at the electronic device 102 (FIG. 1), and the device data may include the images 116, 118, and 120 shown in the example of drawing application 108. Example communication transceivers 502 include wireless personal area network (WPAN) radios compliant with various IEEE 802.15 (also referred to as Bluetooth™) standards, wireless local area network (WLAN) radios compliant with any of the various IEEE 802.11 (also referred to as WiFi™) standards, wireless wide area network (WWAN) radios for cellular telephony, wireless metropolitan area network (WMAN) radios compliant with various IEEE 802.15 (also referred to as WiMAX™) standards, and wired local area network (LAN) Ethernet transceivers.

The electronic device 500 may also include one or more data input ports 504 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones or cameras. Additionally, the electronic device 500 may include media capture components 508, such as an integrated microphone to capture audio and a camera to capture still images and/or video media content.

The electronic device 500 includes one or more processors 510 (e.g., any of microprocessors, controllers, and the like), or a processor and memory system (e.g., implemented in an SoC), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 512. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 500 also includes one or more memory devices 514 that enable data storage, examples of which include random access memory (RAM), non-volatile memory (e.g., read-only memory (ROM), flash memory, EPROM, EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 500 may also include a mass storage media device.

A memory device 514 provides data storage mechanisms to store the device data 506, other types of information and/or data, and various device applications 516 (e.g., software applications). For example, an operating system 518 can be maintained as software instructions within a memory device and executed on the processors 510. The device applications may also include a device manager, such as any form of a control application, software application, signal-processing and control module, code that is native to a particular device, a hardware abstraction layer for a particular device, and so on. In embodiments, the electronic device also includes a drawing application 520 that implements pen tool editing modes. The drawing application 520 is an example of the drawing application 108 at the electronic device 102 shown in FIG. 1.

The electronic device 500 also includes an audio and/or video processing system 522 that generates audio data for an audio system 524 and/or generates display data for a display system 526. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 528. Additionally, the audio system and/or the display system may be external components to the electronic device, or alternatively, are integrated components of the example electronic device.

As described above, pen tool editing modes provide that a user can select a new drawing region using the pen tool, and a first pen tool editing mode can be initiated to create an image in the new drawing region. A user may also select an existing drawing region using the pen tool, and a second pen tool editing mode may be initiated to create an image (or add to an existing image) in the existing drawing region. A user can also select an image using the pen tool, and a third pen tool editing mode may be initiated that enables the user to edit the image. The various pen tool editing modes are initiated according to pen tool inputs and without invoking a selection tool of the drawing application. Although embodiments of pen tool editing modes have been described in language specific to features and/or methods, the subject of the appended claims is not necessarily limited to the specific features or methods described. Rather, the specific features and methods are disclosed as example implementations of pen tool editing modes.

1. A drawing system, comprising:
one or more drawing regions of a drawing application, the one or more drawing regions configured for image creation and editing;
a pen tool of the drawing application, the pen tool configured for selection to both create an image for display and edit the image in a drawing region; and
pen tool editing modes each configured for initiation based on a pen tool input.

2. The drawing system as recited in claim 1, wherein the pen tool editing modes comprise at least:
a first pen tool editing mode initiated responsive to the pen tool input to create the image in a new drawing region;
a second pen tool editing mode initiated responsive to the pen tool input within an existing drawing region to create the image in the existing drawing region; and
a third pen tool editing mode initiated responsive to the pen tool input as a selection of the image to edit the image.

3. The drawing system as recited in claim 2, wherein the first pen tool editing mode enables a segment of the image to be created in the new drawing region when the pen tool input to create the image in the new drawing region sets an anchor point.

4. The drawing system as recited in claim 2, wherein the second pen tool editing mode enables a segment of the image to be created in the existing drawing region when the pen tool input to create the image within the existing drawing region sets an anchor point.

5. The drawing system as recited in claim 2, wherein a size of the existing drawing region of the image is based on a size of the image, and wherein the second pen tool editing mode prevents the existing drawing region from expanding.

6. The drawing system as recited in claim 2, wherein the third pen tool editing mode enables multiple anchor points of the image to be selected concurrently and segments of the image edited together based on the concurrent selection of the anchor points.

7. The drawing system as recited in claim 2, wherein the third pen tool editing mode enables anchor points to be added to a segment of the image when the selection of the image is a selection of the segment of the image.

8. The drawing system as recited in claim 2, wherein the image is displayed with anchor points responsive to the pen tool input as the selection of the image to edit the image in the third pen tool editing mode.

9. The drawing system as recited in claim 8, wherein the third pen tool editing mode enables the anchor points of the image to be edited and segments of the image to be adjusted based on the anchor points being edited.

10. The drawing system as recited in claim 1, wherein the pen tool editing modes are each configured for initiation without switching from the pen tool to a selection tool.

11. The drawing system as recited in claim 1, wherein the pen tool editing modes enable a Bezier curve to be created based on a sequence of inputs to set anchor points for the Bezier curve, and wherein a current anchor point is connected to a last-set anchor point with a segment of the Bezier curve when the current anchor point is set.

12. The drawing system as recited in claim 11, wherein the pen tool editing modes enable additional anchor points to be added to the Bezier curve responsive to a selection to edit the Bezier curve.

13. A method, comprising:
receiving a selection of a pen tool that is selectable to both create an image for display and edit the image in a drawing region of a drawing application;
receiving a pen tool input that initiates one of multiple pen tool editing modes that comprise:
a first pen tool editing mode initiated responsive to the pen tool input to create the image in a new drawing region;
a second pen tool editing mode initiated responsive to the pen tool input within an existing drawing region to create the image in the existing drawing region; and
a third pen tool editing mode initiated responsive to the pen tool input as a selection of the image to edit the image.

14. The method as recited in claim 13, wherein one of the multiple pen tool editing modes is initiated based on the pen tool input and without switching from the pen tool to a selection tool.

15. The method as recited in claim 13, further comprising determining that the pen tool input corresponds to the new drawing region, the existing drawing region, or the image.

16. The method as recited in claim 15, wherein the pen tool input is determined to correspond to the image when the pen tool input corresponds to an input near the image.

17. The method as recited in claim 13, wherein one of the multiple pen tool editing modes is initiated by switching from a previous pen tool editing mode to a current pen tool editing mode responsive to the pen tool input and without switching to a selection tool.

18. A method comprising:
receiving a selection of a pen tool that is selectable to both create and edit images in one or more drawing regions of a drawing application;
receiving a first pen tool input to create an image;
initiating a first pen tool editing mode based on the first pen tool input;
receiving a second pen tool input to edit the image; and
initiating a second pen tool editing mode based on the second pen tool input and without switching from the pen tool to a selection tool.

19. The method as recited in claim 18, wherein:
the first pen tool editing mode is initiated to one of create the image in a new drawing region or create the image in an existing drawing region; and
the second pen tool editing mode is initiated to edit the image.

20. The method as recited in claim 18, further comprising:
receiving a sequence of single-action inputs to set anchor points for a Bezier curve; and
connecting a current anchor point to a last-set anchor point with a segment of the Bezier curve responsive to setting the current anchor point.
